(19) United States
(12) Patent Application Publication
(10) Pub. No.: US 2026/0359625 A1
(43) Pub. Date: Nov. 12, 2026

(54) INTERACTIVE VISION-LANGUAGE MODEL FOR STEP-BY-STEP INSTRUCTIONS

(71) Applicant: QUALCOMM Incorporated, San Diego, CA (US)

(72) Inventors: Apratim BHATTACHARYYA, San Diego, CA (US); Roland MEMISEVIC, Toronto (CA); Sanjay HARESH, Toronto (CA); Litian LIU, San Diego, CA (US)

(21) Appl. No.: 19/300,511

(22) Filed: Aug. 14, 2025

Related U.S. Application Data
(60) Provisional application No. 63/803,458, filed on May 9, 2025.

(51) Int. Cl. G06N 3/08; G06N 3/044

(52) U.S. Cl. CPC G06N 3/08; G06N 3/044

(57) ABSTRACT

A processor-implemented method for providing interactive step-by-step instruction using a vision-language model includes receiving, by the vision-language model, a plan for performing a target activity. The vision-language model processes the plan to generate one or more instructions for performing the target activity. The vision-language model prompts a user to perform a first user action based on a first instruction of the one or more instructions. The vision-language model receives at least a first frame of a video stream. The vision-language model determines a first inference indicating whether the first user action corresponds to the first instruction. The vision-language model generates a first updated plan for performing the target activity based on the first inference. The vision-language model prompts the user to perform a second user action based on the first updated plan.

### CROSS-REFERENCE TO RELATED APPLICATION

The present application claims the benefit of U.S. Provisional Patent Application No. 63/803,458, filed on May 9, 2025, and titled “INTERACTIVE VISION-LANGUAGE MODEL FOR STEP-BY-STEP INSTRUCTIONS,” the disclosure of which is expressly incorporated by reference in its entirety.

### FIELD OF THE DISCLOSURE

Aspects of the present disclosure generally relate to artificial neural networks, and more specifically to interactive vision-language models for step-by-step instructions.

### BACKGROUND

Artificial neural networks may comprise interconnected groups of artificial neurons (e.g., neuron models). The artificial neural network (ANN) may be a computational device or be represented as a method to be performed by a computational device. Various ANN model structures are available for consideration. Convolutional neural networks (CNNs) are a type of feed-forward ANN. Convolutional neural networks may include collections of neurons that each have a receptive field and that collectively tile an input space.

A transformer ANN structure makes use of attention mechanisms that may enable the model to process input sequences in a parallel and efficient manner. An attention mechanism allows the model to focus on different parts of the input sequence at different times. A transformer ANN structure may be of particular use for tasks that involve sequence modeling, such as text generation by a large language model (LLM).

Multimodal LLMs such as large multimodal models (LMMs) are another type of ANN model that can process multiple types of data modalities (e.g., text, images, audio, or video). Conventional multimodal LLMs may have advanced conversational abilities but are unable to providing live, interactive step-by-step guidance, an important capability for future artificial intelligence (AI) assistants.

### SUMMARY

Various aspects of the present disclosure are directed to an apparatus. The apparatus has at least one memory and one or more processors coupled to the at least one memory. The processor(s) is configured to receive, by a vision-language model, a plan for performing a target activity. The processor(s) is also configured to process, by the vision-language model, the plan to generate one or more instructions for performing the target activity. The processor(s) is additionally configured to prompt, by the vision-language model, a user to perform a first user action based on a first instruction of the one or more instructions. The processor(s) is further configured to receive, by the vision-language model, at least a first frame of a video stream. The processor(s) is still further configured to determine, by the vision-language model, a first inference indicating whether the first user action corresponds to the first instruction. The processor(s) is also configured to generate, by the vision-language model, a first updated plan for performing the target activity based on the first inference. The processor(s) is further configured to prompt, by the vision-language model, the user to perform a second user action based on the first updated plan.

In some aspects of the present disclosure, a processor-implemented method includes receiving, by a vision-language model, a plan for performing a target activity. The processor-implemented method also includes processing, by the vision-language model, the plan to generate one or more instructions for performing the target activity. The processor-implemented method additionally includes prompting, by the vision-language model, a user to perform a first user action based on a first instruction of the one or more instructions. The processor-implemented method further includes receiving, by the vision-language model, at least a first frame of a video stream. The processor-implemented method still further includes determining, by the vision-language model, a first inference indicating whether the first user action corresponds to the first instruction. The processor-implemented method also includes generating, by the vision-language model, a first updated plan for performing the target activity based on the first inference. The processor-implemented method further includes prompting, by the vision-language model, the user to perform a second user action based on the first updated plan.

Various aspects of the present disclosure are directed to an apparatus. The apparatus includes means for receiving, by a vision-language model, a plan for performing a target activity. The apparatus also includes means for processing, by the vision-language model, the plan to generate one or more instructions for performing the target activity. The apparatus additionally includes means for prompting, by the vision-language model, a user to perform a first user action based on a first instruction of the one or more instructions. The apparatus further includes means for receiving, by the vision-language model, at least a first frame of a video stream. The apparatus still further includes means for determining, by the vision-language model, a first inference indicating whether the first user action corresponds to the first instruction. The apparatus also includes means for generating, by the vision-language model, a first updated plan for performing the target activity based on the first inference. The apparatus further includes means for prompting, by the vision-language model, the user to perform a second user action based on the first updated plan.

Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 illustrates an example implementation of a neural network using a system-on-a-chip (SOC), including a general-purpose processor in accordance with certain aspects of the present disclosure.

FIG. 2 is an illustrative block diagram of an example machine learning (ML) model represented by an artificial neural network (ANN), in accordance with various aspects of the present disclosure.

FIG. 3 is a block diagram illustrating an exemplary software architecture that may modularize artificial intelligence (AI) functions, in accordance various with aspects of the present disclosure.

FIG. 4 is a block diagram illustrating an example architecture for a vision-language model, in accordance with various aspects of the present disclosure.

FIG. 5 is a block diagram illustrating an example interactive step-by-step instruction using the vision-language model of FIG. 4, in accordance with various aspects of the present disclosure.

FIG. 6 is a flow diagram illustrating a processor-implemented method for interactive step-by-step instructions using a vision-language model, in accordance with various aspects of the present disclosure.

### DETAILED DESCRIPTION

The detailed description set forth below, in connection with the appended drawings, is intended as a description of various configurations and is not intended to represent the only configurations in which the concepts described may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

Based on the teachings, one skilled in the art should appreciate that the scope of the disclosure is intended to cover any aspect of the disclosure, whether implemented independently of or combined with any other aspect of the disclosure. For example, an apparatus may be implemented or a method may be practiced using any number of the aspects set forth. In addition, the scope of the disclosure is intended to cover such an apparatus or method practiced using other structure, functionality, or structure and functionality in addition to or other than the various aspects of the disclosure set forth. It should be understood that any aspect of the disclosure disclosed may be embodied by one or more elements of a claim.

The word “exemplary” is used to mean “serving as an example, instance, or illustration.” Any aspect described as “exemplary” is not necessarily to be construed as preferred or advantageous over other aspects.

Although particular aspects are described, many variations and permutations of these aspects fall within the scope of the disclosure. Although some benefits and advantages of the preferred aspects are mentioned, the scope of the disclosure is not intended to be limited to particular benefits, uses or objectives. Rather, aspects of the disclosure are intended to be broadly applicable to different technologies, system configurations, networks, and protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

Recent advancements have significantly enhanced the ability of artificial intelligence (AI) systems. Although conventional multimodal large language models (LLMs) can process audio, speech, and visual inputs to engage in conversations about images or videos, the conversational capabilities of conventional multimodal LLMs are limited to answering questions on visual understanding and reasoning tasks, such as describing images or answering questions that involve inferring object positions and relations in the visual input. Conventional multimodal LLMs fail to provide truly situated, live, conversational experiences that humanoid robots or real-time video-call chatbots may be expected to provide in the future. Rather, conventional multimodal LLMs may be limited to turn-based interactions. Turn-based interactions refers to a model that may only produce responses when prompted by the user or a narration task. As such, conventional multimodal LLMs take an image or a video clip as input and produce a response, but are unable to respond interactively to events in an input video stream.

An artificial intelligence (AI) assistant is software that uses AI to understand natural language voice commands and complete tasks for a user. To be useful as an AI assistant, vision-language models should be able to guide a user live -- by providing interactive step-by-step instructions. Live guidance may encompass key abilities, such as i) providing a next instruction, ii) detecting if the instruction has been successfully accomplished by the user, and iii) detecting any mistakes made by the user and alerting the user as soon as possible, if the instruction has not been successfully accomplished (e.g., performed correctly). For example, a vision-language model may guide a user while making a cake. At the stage where the cake batter is being made, the next instruction would specify which ingredients to add to the batter. The vision-language model has to detect whether the user has added the correct ingredients to the batter. In case of a mistake (e.g., the user adds pepper instead of sugar to the batter), the vision-language model should alert the user as soon as the vision-language model observes that a mistake has been made. That is, the vision-language model has to be able to process a video stream as input and react interactively to events in the video stream. However, as discussed, conventional vision-language models and multimodal LLMs may be limited to turn-based interactions. Additionally, some conventional online vision-language models are limited to narration tasks.

Accordingly, aspects of the present disclosure are directed to an interactive vision-language model for step-by-step instructions. In various aspects, the vision-language model may comprise a vision encoder and language model backbone to produce step-by-step instructions and feedback. For a given set of step-by-step instructions, the vision-language model may provide a next instruction to the user, wait for the user to complete the instruction or make a mistake, and provide a feedback (e.g., a response) message. The feedback message may comprise a subsequent instruction or may alert the user of a mistake.

Particular aspects of the subject matter described in this disclosure can be implemented to realize one or more of the following potential advantages. In some examples, the described techniques for a vision-language model (e.g., prompting a user to perform an instruction, determining whether the user action in a video stream corresponds to the instruction and prompting the user to perform a next instruction updated plan) enable interactively providing step-by-step instructions with feedback to a user. Furthermore, the disclosed techniques enable a reduced model size suitable for use on resource-limited edge devices, such as smartphones and wearable computing devices.

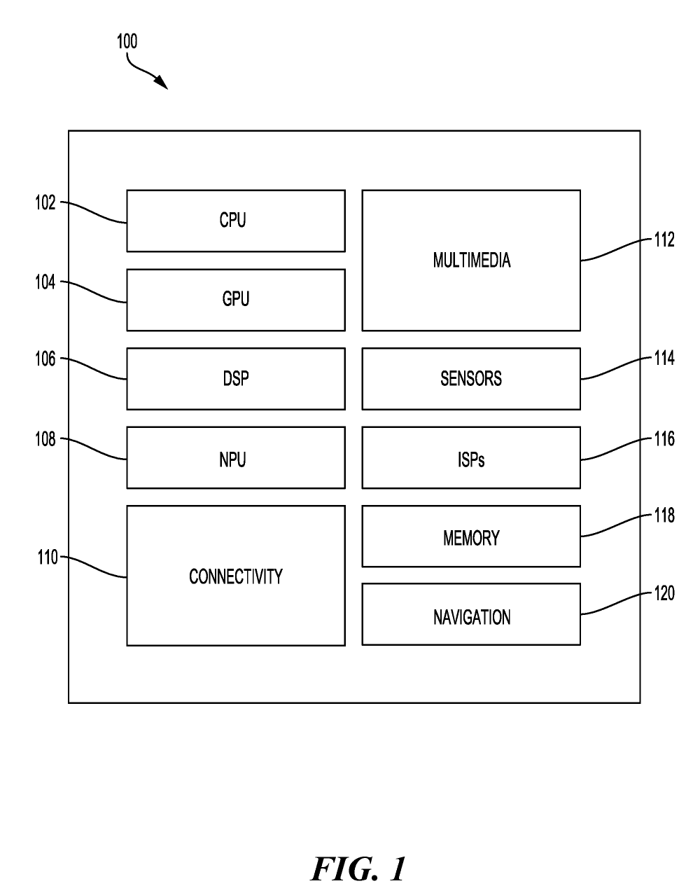

FIG. 1 illustrates an example implementation of a system-on-a-chip (SOC) 100, which may include a central processing unit (CPU) 102 or a multi-core CPU, as well as a graphics processing unit (GPU) 104, and/or a neural processing unit (NPU) 108 configured for providing interactive step-by-step instruction using a vision-language model. Variables (e.g., neural signals and synaptic weights), system parameters associated with a computational device (e.g., neural network with weights), delays, frequency bin information, and task information may be stored in a memory block associated with the NPU 108, in a memory block associated with the CPU 102, in a memory block associated with the GPU 104, in a memory block associated with a digital signal processor (DSP) 106, in a memory block 118, or may be distributed across multiple blocks. Instructions executed at the CPU 102 may be loaded from a program memory associated with the CPU 102 or may be loaded from a memory block 118.

The SOC 100 may also include additional processing blocks tailored to specific functions, such as a GPU 104, a DSP 106, a connectivity block 110, which may include fifth generation (5G) connectivity, fourth generation long term evolution (4G LTE) connectivity, Wi-Fi connectivity, USB connectivity, Bluetooth connectivity, and the like, and a multimedia processor 112 that may, for example, detect and recognize gestures. In one implementation, the NPU 108 is implemented in the CPU 102, DSP 106, and/or GPU 104. The SOC 100 may also include a sensor processor 114, image signal processors (ISPs) 116, and/or navigation module 120, which may include a global positioning system.

The SOC 100 may be based on an ARM, RISC-V (RISC-five), or any reduced instruction set computing (RISC) architecture. In aspects of the present disclosure, the instructions loaded into the general-purpose processor 102 may include code to receive, by a vision-language model, a plan for performing a target activity. The instructions loaded into the general-purpose processor 102 may also include code to process, by the vision-language model, the plan to generate one or more instructions for performing the target activity. The instructions loaded into the general-purpose processor 102 may additionally include code to prompt, by the vision-language model, a user to perform a first user action based on a first instruction of the one or more instructions. The instructions loaded into the general-purpose processor 102 may further include code to receive, by the vision-language model, at least a first frame of a video stream. The instructions loaded into the general-purpose processor 102 may further still include code to determine, by the vision-language model, a first inference indicating whether the first user action corresponds to the first instruction. The instructions loaded into the general-purpose processor 102 may also include code to generate, by the vision-language model, a first updated plan for performing the target activity based on the first inference. The instructions loaded into the general-purpose processor 102 may further include code to prompt, by the vision-language model, the user to perform a second user action based on the first updated plan.

Neural networks may be designed with a variety of connectivity patterns. In feed-forward networks, information is passed from lower to higher layers, with each neuron in a given layer communicating to neurons in higher layers. A hierarchical representation may be built up in successive layers of a feed-forward network, as described above. Neural networks may also have recurrent or feedback (also called top-down) connections. In a recurrent connection, the output from a neuron in a given layer may be communicated to another neuron in the same layer. A recurrent architecture may be helpful in recognizing patterns that span more than one of the input data chunks that are delivered to the neural network in a sequence. A connection from a neuron in a given layer to a neuron in a lower layer is called a feedback (or top-down) connection. A network with many feedback connections may be helpful when the recognition of a high-level concept may aid in discriminating the particular low-level features of an input.

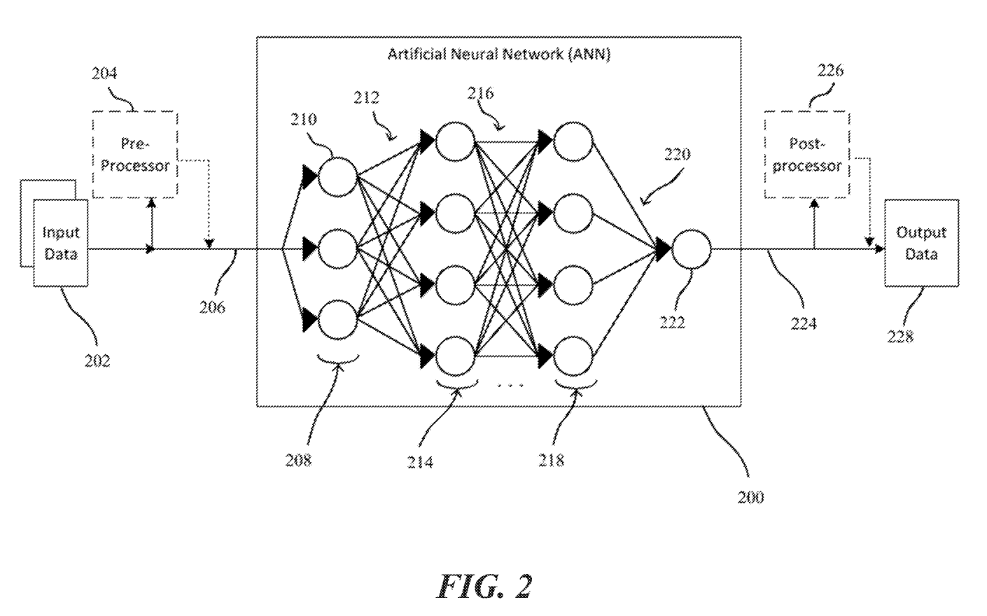

FIG. 2 is an illustrative block diagram of an example machine learning (ML) model represented by an artificial neural network (ANN) 200. The ANN 200 may receive input data 206 which may include one or more bits of data 202, pre-processed data output from pre-processor 204 (optional), or some combination thereof. Here, data 202 may include training data, verification data, application-related data, or the like, based, for example, on the stage of deployment of the ANN 200. A pre-processor 204 may be included within the ANN 200 in some other implementations. The pre-processor 204 may, for example, process all or a portion of the data 202, which may result in some of the data 202 being changed, replaced, deleted, etc. In some implementations, the pre-processor 204 may add additional data to the data 202.

The ANN 200 includes at least one first layer 208 of artificial neurons 210 to process input data 206 and provide resulting first layer data via connections or “edges” such as the edges 212 to at least a portion of at least one second layer 214. The second layer 214 processes data received via the edges 212 and provides second layer output data via the edges 216 to at least a portion of at least one third layer 218. The third layer 218 processes data received via the edges 216 and provides third layer output data via the edges 220 to at least a portion of a final layer 222 including one or more neurons to provide output data 224. All or part of the output data 224 may be further processed in some manner by an optional post-processor 226. Thus, in certain examples, the ANN 200 may provide output data 228 that is based on output data 224, post-processed data output from the post-processor 226, or some combination thereof.

The post-processor 226 may be included within the ANN 200 in some other implementations. The post-processor 226 may, for example, process all or a portion of the output data 224 which may result in the output data 228 being different, at least in part, to the output data 224, as result of data being changed, replaced, deleted, etc. In some implementations, the post-processor 226 may be configured to add additional data to the output data 224. In this example, the second layer 214 and third layer 218 represent intermediate or hidden layers arranged in a hierarchical or other like structure. Although not explicitly shown, there may be one or more further intermediate layers between the second layer 214 and the third layer 218.

The structure and training of artificial neurons 210 in the various layers may be tailored to specific requirements of an application. Within a given layer such as the first layer 208, second layer 214, or third layer 218 of the ANN 200, some or all of the neurons may be configured to process information provided to the layer and output corresponding transformed information from the layer. For example, transformed information from a layer may represent a weighted sum of the input information associated with or otherwise based on a non-linear activation function or other activation function used to “activate” artificial neurons of a next layer. Artificial neurons in such a layer may be activated by or be responsive to parameters such as the previously described weights and biases of the ANN 200. The weights and biases of the ANN 200 may be adjusted during a training process or during operation of the ANN 200. The weights of the various artificial neurons may control a strength of connections between layers or artificial neurons, while the biases may control a direction of connections between the layers or artificial neurons. An activation function may select or determine whether an artificial neuron transmits its output to the next layer or not in response to its received data.

Different activation functions may model different types of non-linear relationships. By introducing non-linearity into an ML model, an activation function allows the configuration for the ML model to change in response to identifying or detecting complex patterns and relationships in the input data 206. Some non-exhaustive example activation functions include a sigmoid-based activation function, a hyperbolic tangent (tanh)-based activation function, a convolutional activation function, up-sampling, pooling, and a rectified linear unit (ReLU)-based activation function.

Training of an ML model, such as the ANN 200, may be conducted using training data. Training data may include one or more datasets the ANN 200 may use to identify patterns or relationships. Training data may represent various types of information, including written, visual, audio, environmental context, operational properties, etc. During training, the parameters (such as the weights and biases) of artificial neurons 210 may be changed, such as to minimize or otherwise reduce a loss function or a cost function. A training process may repeat multiple times to fine-tune the ANN 200 with each iteration.

Various ANN model structures are available for consideration. For example, in a feed-forward ANN structure, each artificial neuron 210 in layer 214 receives information from the previous layer (such as, one or more artificial neurons 210 in layer 208) and produces information for the next layer (such as, one or more artificial neurons 210 in layer 218). In a convolutional ANN structure, some layers may be organized into filters that extract features from data, such as the training data or the input data. In a recurrent ANN structure, some layers may have connections that allow for processing of data across time, such as for processing information having a temporal structure, such as time series data forecasting.

A transformer ANN structure makes use of attention mechanisms that may enable the model to process input sequences in a parallel and efficient manner. An attention mechanism allows the model to focus on different parts of the input sequence at different times. Attention mechanisms may be implemented using a series of layers known as attention layers to compute weighted sums of input features based on a similarity between different elements of the input sequence. A transformer ANN structure may include a series of feed-forward ANN layers whose configurations may change in response to identifying non-linear relationships between the input and output sequences, which may also be referred to as a process of “learning” by the ANN layers. The output of a transformer ANN structure may be obtained by applying a linear transformation to the output of a final attention layer. A transformer ANN structure may be of particular use for tasks that involve sequence modeling, or other like processing, such as text generation. A large language model may be a particularly useful implementation of a transformer ANN structure.

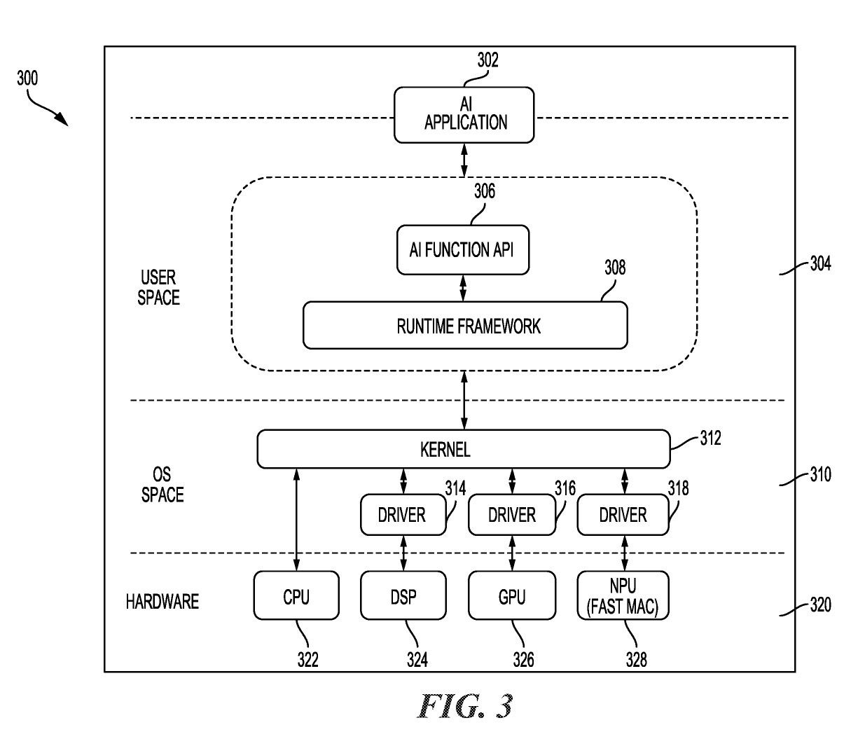

FIG. 3 is a block diagram illustrating an exemplary software architecture 300 that may modularize artificial intelligence (AI) functions. Using the architecture 300, applications may be designed that may cause various processing blocks of an SOC 320 (for example a CPU 322, a DSP 324, a GPU 326 and/or an NPU 328) (which may be similar to SoC 100 of FIG. 1) to support interactive step-by-step instruction using a vision-language model for an AI application 302, according to aspects of the present disclosure. The architecture 300 may, for example, be included in a computational device, such as a smartphone.

The AI application 302 may be configured to call functions defined in a user space 304 that may, for example, provide for text, video, and/or sound generation. The AI application 302 may make a request to compiled program code associated with a library defined in an AI function application programming interface (API) 306. This request may ultimately rely on the output of a deep neural network configured to provide an inference response based on input, for example.

The run-time engine 308, which may be compiled code of a runtime framework, may be further accessible to the AI application 302. The AI application 302 may cause the run-time engine 308, for example, to request an inference at a particular time interval or triggered by an event detected by the user interface of the AI application 302. When caused to provide an inference response, the run-time engine 308 may in turn send a signal to an operating system in an operating system (OS) space 310, such as a Kernel 312, running on the SOC 320. In some examples, the Kernel 312 may be a LINUX Kernel. The operating system, in turn, may cause non-contiguous attention masks to be processed on the CPU 322, the DSP 324, the GPU 326, the NPU 328, or some combination thereof. The CPU 322 may be accessed directly by the operating system, and other processing blocks may be accessed through a driver, such as a driver 314, 316, or 318 for, respectively, the DSP 324, the GPU 326, or the NPU 328. In the exemplary example, the deep neural network may be configured to run on a combination of processing blocks, such as the CPU 322, the DSP 324, and the GPU 326, or may be run on the NPU 328.

As described, aspects of the present disclosure are directed to a vision-language model for interactive step-by-step instructions. The vision-language model includes a vision encoder and a language model as a backbone. Given a plan with a set of step-by-step instructions, the vision-language model may provide a next instruction of the plan to the user, wait for the user to complete the action specified in the instruction or make a mistake, and provide a feedback message.

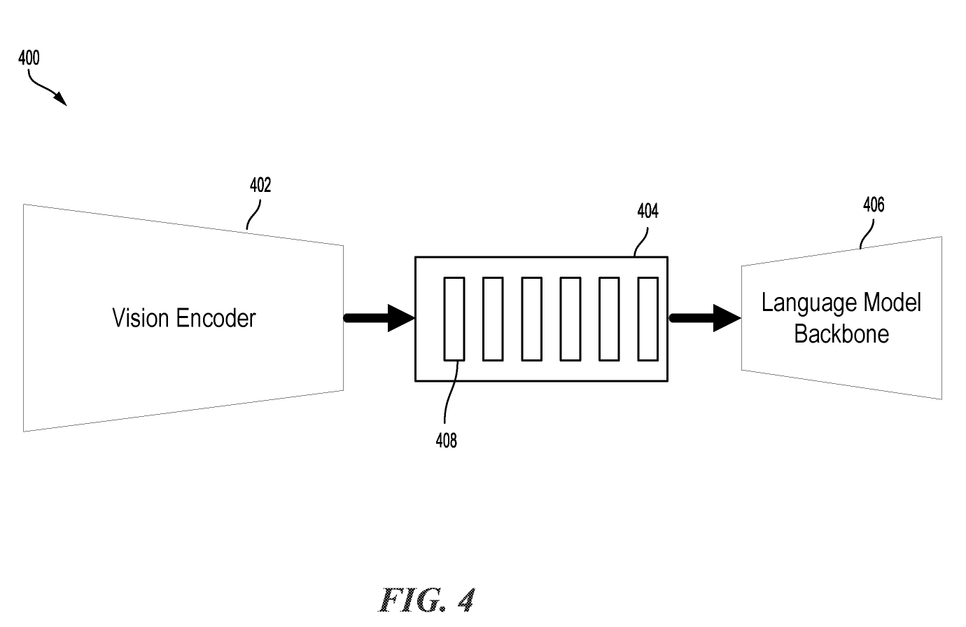

FIG. 4 is a block diagram illustrating an example architecture for a vision-language model 400, in accordance with various aspects of the present disclosure. The example architecture may include a vision encoder 402, an adapter 404, and a language model backbone 406. The vision encoder 402 may comprise but is not limited to a vision transformer (ViT ), for instance.

The adapter 404 may comprise multiple transformer layers 408. In some aspects, the adapter 404 may comprise (but is not limited to) a query transformer (Q-Former) style adapter, for example. The adapter 404 may reduce the raw visual processing load of a language model backbone 406. The adapter 404 may start from a random latent representation and use six cross-attention layers to gradually blend in the important visual information identified in an input video frame by the vision encoder 402. For every input video frame, the adapter 404 may produce a fixed number (K) of video related tokens. The video related tokens may be input to the language model backbone 406. The language model backbone 406 may comprise (but is not limited to) a recurrent state space model (e.g., Mamba). State space models use state variables to describe a system by a set of first-order differentials or difference equations. The language model backbone 406 may interleave the video related tokens from the adapter 404 with text tokens corresponding to the plan, instructions, and feedback.

To respond at the appropriate time step, the vision-language model 400 may use special tokens: a <vision> token and <response> token. The <vision> token may enable the vision-language model 400 to interactively ask for the next video frame (e.g., of the user performing steps of the target activity) as input. The <response> token may enable the vision-language model 400 to respond to a detected action with either an instruction or a feedback message at an appropriate time.

The vision-language model 400 may implement an iterative re-planning process. For example, the vision-language model 400 may provide an initial plan with step-by-step instructions as input. To accommodate long input video streams (e.g., videos longer than 10 minutes (e.g., 30 minutes or an hour)), the vision-language model 400 may re-plan the target activity (e.g., making a cake, perform an exercise (e.g., jumping jacks, a yoga pose) or another instruction-driven activity) after every generated feedback message. For instance, after each generated feedback message the vision-language model 400 may determine an updated plan.

Keeping the embedded tokens corresponding to every frame of a very long video in a context window may be challenging on resource-limited edge devices such as mobile phones or smart glasses. By re-planning the steps to complete the activity, the vision-language model 400 may abstract away information in old video frames into the updated plan. Accordingly, the vision-language model 400 may beneficially enable deletion of the tokens corresponding to the old (e.g., previously processed) video frames from the context window.

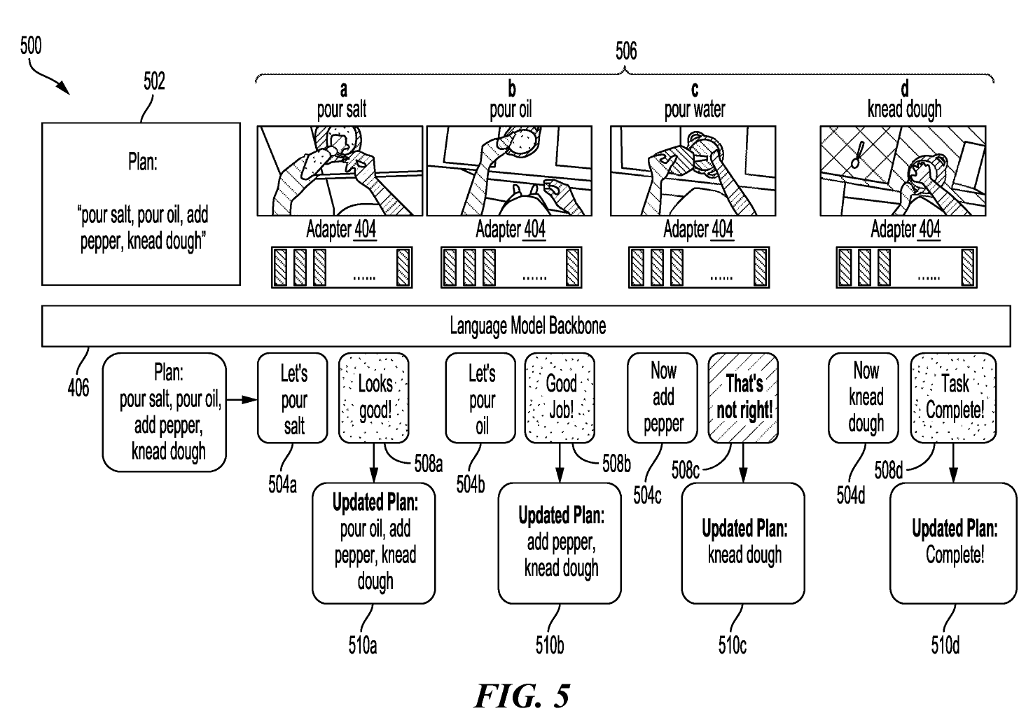

FIG. 5 is a block diagram illustrating an example interactive step-by-step instruction using the vision-language model 400 of FIG. 4, in accordance with various aspects of the present disclosure. Referring to FIG. 5, the vision-language model 400 receives a plan 502 for a target activity. The plan 502 may have a target activity such as kneading dough, for instance. The language model backbone 406 processes the plan 502 to determine a set of instruction steps. For example, the plan 502 may specify “pour salt, pour oil, add pepper, knead dough.” The language model backbone 406 may determine a first step 504a to “pour salt,” a second step 504b to “pour oil,” a third step 504c to “add pepper,” and a fourth step 504d to “knead dough.”

The vision-language model 400 issues an instruction for the first step 504a, “Let’s pour salt.” The vision-language model 400 receives a <vision> token to trigger processing of the first frame 506a of a streaming video input of user actions or attempt to perform the target activity. The first frame 506a of the streaming video input may be processed by the vision encoder 402 to determine important video information. For example, the vision encoder 402 may identify the position of the user’s hands, objects within each hand, and a receptacle (such as a bowl). In the first video frame 506a, the vision-language model 400 may determine that the user has a saltshaker in their left hand and may generate an inference indicating that an activity of pouring is included in the first video frame 506a. A <response> token may be provided to trigger a response to the determined activity of the first video frame 506a.

The vision-language model 400 may determine that the user has performed the first step 504a and may output a first response 508a “Looks good!” to provide a positive affirmation that the step has been properly completed. After the first response 508a is provided, an updated plan 510a is generated based on the first response 508a. In this example, because the first step 504a (“pour salt”) has been properly completed, the first step 504a may not be included the updated plan 510a.

The vision-language model 400 issues an instruction for the next step of the updated plan 510a (e.g., the second step 504b “pour oil”). The vision-language model may receive the <vision> token to trigger processing of a next video frame 506b of the streaming video input. The vision-language model 400 may generate an inference indicating that the second step 504b has been properly completed. Thereafter, a second response 508b “Good job!” may be triggered and output. In turn, the vision-language model 400 may generate an updated plan 510b.

The vision-language model 400 may continue to process the steps in the updated plan 510b, determining the user actions in the next video frames 506c, 506d, determining if the correct steps 504c, 504d have been completed, and generating responses 508c, 508d until there are no further steps to perform in the updated plan 510d. The vision-language model 400 may then indicate the target activity has been completed (e.g., final response 508d “Task complete!”). In some aspects, where an incorrect action (e.g., identified in response 508c, “That’s not right!”) is determined (e.g., at the third step 504c “add pepper,” the third video frame 506c shows that the user poured water), the vision-language model 400 may determine an incorrect action and may instruct a corrective action. In this example, the vision-language model 400 may determine that the amount of water poured in the third video frame 506c is not a significant error. As such the vision-language model 400 may generate the updated plan (510c) including an instruction to knead dough. In another example, where the user has inadvertently skipped a step or performed the instructions in the wrong order (e.g., “adding pepper” before “pour oil”), the vision-language model 400 may determine a corrective action in the updated plan to perform the skipped step (e.g., pour oil”).

To enable this interactive mode of operation, the vision-language model 400 may be trained to respond at an appropriate time step when the user has successfully completed or attempted to perform the provided instruction. That is, the vision-language model 400 may be trained to determine a time to respond (e.g., “when to speak”). In addition, to recognize the diverse set of possible mistakes that may be made by the user, the vision-language model 400 may be trained using a data augmentation scheme using grounded counterfactuals, for example.

The vision-language model 400 may be trained in two stages. In a pre-training stage, the vision-language model 400 may be trained to align the vision embeddings obtained from the adapter 404 to the text embeddings of the language model backbone 406. To this end, only the adapter 404 is trained and a diverse mix of image and video datasets may be used, to enable visual skills such as grounding to an object and fine-grained actions understanding. An image dataset, such as the large vocabulary instance segmentation (LVIS), may ground the vision-language model 400 to diverse household objects, where the vision-language model 400 may be trained to caption images (e.g., a frame of a streaming video), to recognize objects in the image, and to predict bounding boxes of the objects in the image. The vision-language model 400 may also be trained to narrate videos and enable the vision-language model 400 to be grounded to the fine-grained actions in such large-scale egocentric datasets with cooking activities. During a fine-tuning phase, the vision-language model 400 may be trained to provide the appropriate instructions and feedback at the appropriate time using the <vision> and <response> special tokens.

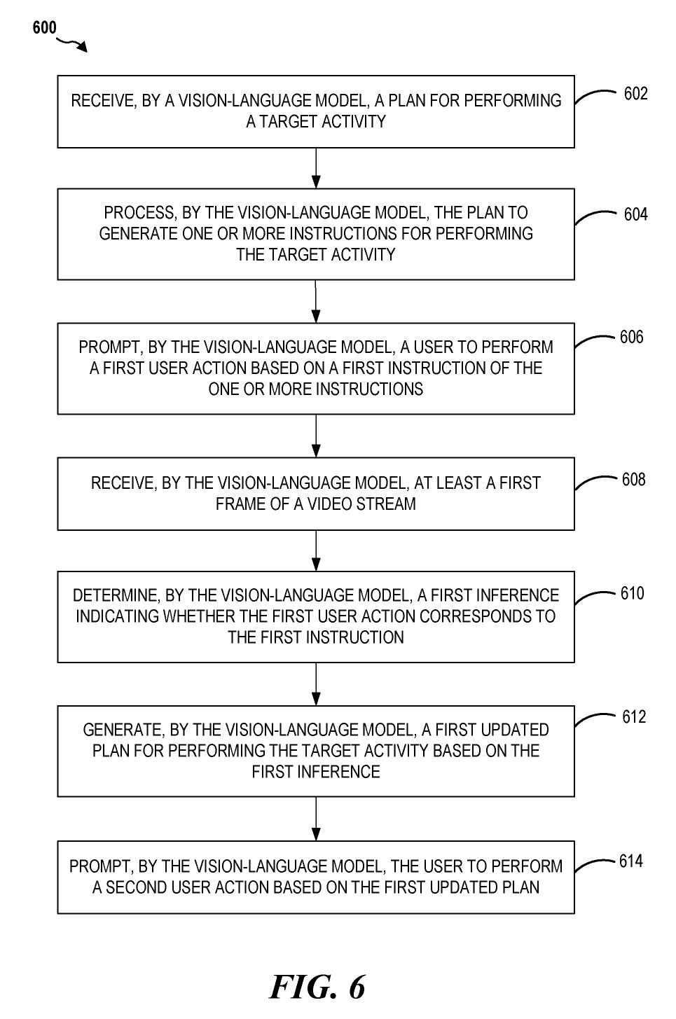

FIG. 6 is a flow diagram illustrating a processor-implemented method 600 of interactive step-by-step instruction using a vison language model, in accordance with various aspects of the present disclosure. The processor-implemented method 600 may be performed by one or more processors such as the CPU (e.g., 102, 322), GPU (e.g., 104, 326), and/or other processing unit (e.g., DSP 324, NPU 328), for example.

Referring to FIG. 6, at block 602, the one or more processors receive, by a vision-language model, a plan for performing a target activity. For example, as described with respect to FIG. 5, a plan 502 for a target activity may be received by the vision-language model 400. The plan 502 may have a target activity such as kneading dough, for instance.

At block 604, the one or more processors process, by the vision-language model, the plan to generate one or more instructions for performing the target activity. For example, as described with respect to FIG. 5, the plan 502 may be processed by the language model backbone 406 to determine a set of instruction steps. For example, the plan 502 may specify “pour salt, pour oil, add pepper, knead dough.” The language model backbone 406 may determine a first step 504a to “pour salt,” a second step 504b to “pour oil,” a third step 504c to “add pepper,” and a fourth step 504d to “knead dough.”

At block 606, the one or more processors prompt, by the vision-language model, a user to perform a first user action based on a first instruction of the one or more instructions. For instance, as described with respect to FIG. 5, the vision-language model 400 may issue an instruction for the first step 504a, “Let’s pour salt.”

At block 608, the one or more processors receive, by the vision-language model, at least a first frame of a video stream. As described, for example, with respect to FIG. 5, the vision-language model 400 may receive a <vision> token to trigger processing of the first frame 506a of a streaming video input of user actions or attempt to perform the target activity.

At block 610, the one or more processors determine, by the vision-language model, a first inference indicating whether the first user action corresponds to the first instruction. For instance, as described with respect to FIG. 5, the first frame 506a of the streaming video input may be processed by the vision encoder 402 to determine important video information. For example, the vision encoder 402 may identify the position of the user’s hands, objects within each hand, and a receptacle (such as a bowl). In the first video frame 506a, the vision-language model 400 may determine that the user has a saltshaker in their left hand and may generate an inference indicating that an activity of pouring is included in the first video frame 506a.

At block 612, the one or more processors generate, by the vision-language model, a first updated plan for performing the target activity based on the first inference. For example, as described with respect to FIG. 5, after the first response 508a is provided, an updated plan 510a is generated based on the first response 508a. In this example, because the first step 504a (“pour salt”) has been properly completed, the first step 504a may not be included the updated plan 510a.

At block 614, the one or more processors prompt, by the vision-language model, the user to perform a second user action based on the first updated plan. As described, for example, with respect to FIG. 5, the vision-language model 400 may issue an instruction for the next step of the updated plan 510a (e.g., the second step 504b “pour oil”).

### Example Aspects

Aspect 1: An apparatus, comprising: at least one memory; and at least one processor coupled to the at least one memory, the at least one processor being configured to: receive, by a vision-language model, a plan for performing a target activity; process, by the vision-language model, the plan to generate one or more instructions for performing the target activity; prompt, by the vision-language model, a user to perform a first user action based on a first instruction of the one or more instructions; receive, by the vision-language model, at least a first frame of a video stream; determine, by the vision-language model, a first inference indicating whether the first user action corresponds to the first instruction; generate, by the vision-language model, a first updated plan for performing the target activity based on the first inference; and prompt, by the vision-language model, the user to perform a second user action based on the first updated plan.

Aspect 2: The apparatus of Aspect 1, wherein the at least one processor is further configured to output a first response to the user based on the first inference.

Aspect 3: The apparatus of Aspect 1 or 2, wherein the vision-language model is trained to generate the first response at a timing based on the first user action.

Aspect 4: The apparatus of any preceding Aspect, wherein the first response triggers generation of the first updated plan.

Aspect 5: The apparatus of any preceding Aspect, wherein the first inference indicates that the first user action does not correspond to the first instruction and the at least one processor is further configured to determine, by the vision-language model, at least one corrective action to include in a next updated plan.

Aspect 6: The apparatus of any preceding Aspect, wherein the plan includes a sequence of multiple instructions, and the at least one processor is further configured to: receive, by the vision-language model, at least a second frame of the video stream; determine, by the vision-language model, a second inference indicating whether the second user action corresponds to a next instruction of the first updated plan; generate, by the vision-language model, a second updated plan for performing the target activity based on the second inference; and prompt, by the vision-language model, the user to perform a third user action based on the second updated plan.

Aspect 7: The apparatus of any preceding Aspect, wherein the vision-language model includes a recurrent state space model.

Aspect 8: A processor-implemented method performed by one or more processors, the processor-implemented method comprising: receiving, by a vision-language model, a plan for performing a target activity; processing, by the vision-language model, the plan to generate one or more instructions for performing the target activity; prompting, by the vision-language model, a user to perform a first user action based on a first instruction of the one or more instructions; receiving, by the vision-language model, at least a first frame of a video stream; determining, by the vision-language model, a first inference indicating whether the first user action corresponds to the first instruction; generating, by the vision-language model, a first updated plan for performing the target activity based on the first inference; and prompting, by the vision-language model, the user to perform a second user action based on the first updated plan.

Aspect 9: The processor-implemented method of Aspect 8, further comprising outputting a first response to the user based on the first inference.

Aspect 10: The processor-implemented method of Aspect 8 or 9, wherein the vision-language model is trained to generate the first response at a timing based on the first user action.

Aspect 11: The processor-implemented method of any of Aspects 8-10, wherein the first response triggers generation of the first updated plan.

Aspect 12: The processor-implemented method of any of Aspects 8-11, wherein the first inference indicates that the first user action does not correspond to the first instruction and the vision-language model determines at least one corrective action to include in a next updated plan.

Aspect 13: The processor-implemented method of any of Aspects 8-12, wherein the plan includes a sequence of multiple instructions, and the processor-implemented method further includes: receiving, by the vision-language model, at least a second frame of the video stream; determining, by the vision-language model, a second inference indicating whether the second user action corresponds to a next instruction of the first updated plan; generating, by the vision-language model, a second updated plan for performing the target activity based on the second inference; and prompting, by the vision-language model, the user to perform a third user action based on the second updated plan.

Aspect 14: The processor-implemented method of any of Aspects 8-13, wherein the vision-language model includes a recurrent state space model.

Aspect 15: An apparatus, comprising: means for receiving, by a vision-language model, a plan for performing a target activity; means for processing, by the vision-language model, the plan to generate one or more instructions for performing the target activity; means for prompting, by the vision-language model, a user to perform a first user action based on a first instruction of the one or more instructions; means for receiving, by the vision-language model, at least a first frame of a video stream; means for determining, by the vision-language model, a first inference indicating whether the first user action corresponds to the first instruction; means for generating, by the vision-language model, a first updated plan for performing the target activity based on the first inference; and means for prompting, by the vision-language model, the user to perform a second user action based on the first updated plan.

Aspect 16: The apparatus of Aspect 15, further comprising means for outputting a first response to the user based on the first inference.

Aspect 17: The apparatus of Aspect 15 or 16, wherein the vision-language model is trained to generate the first response at a timing based on the first user action.

Aspect 18: The apparatus of any of Aspects 15-17, wherein the first response triggers generation of the first updated plan.

Aspect 19: The apparatus of any of Aspects 15-18, wherein the first inference indicates that the first user action does not correspond to the first instruction and the apparatus further comprises means for determining, by the vision-language model, at least one corrective action to include in a next updated plan.

Aspect 20: The apparatus of any of Aspects 15-19, wherein the plan includes a sequence of multiple instructions, and the apparatus further includes: means for receiving, by the vision-language model, at least a second frame of the video stream; means for determining, by the vision-language model, a second inference indicating whether the second user action corresponds to a next instruction of the first updated plan; means for generating, by the vision-language model, a second updated plan for performing the target activity based on the second inference; and means for prompting, by the vision-language model, the user to perform a third user action based on the second updated plan.

In one aspect, an apparatus includes means for receiving, by a vision-language model, a plan for performing a target activity; means for processing, by the vision-language model, the plan to generate one or more instructions for performing the target activity; means for prompting, by the vision-language model, a user to perform a first user action based on a first instruction of the one or more instructions; means for receiving, by the vision-language model, at least a first frame of a video stream; means for determining, by the vision-language model, a first inference indicating whether the first user action corresponds to the first instruction; means for generating, by the vision-language model, a first updated plan for performing the target activity based on the first inference; and means for prompting, by the vision-language model, the user to perform a second user action based on the first updated plan. The means for receiving, by a vision-language model, a plan for performing a target activity, the means for processing, by the vision-language model, the plan to generate one or more instructions for performing the target activity, the means for prompting, by the vision-language model, a user to perform a first user action based on a first instruction of the one or more instructions, the means for receiving, by the vision-language model, at least a first frame of a video stream, the means for determining, by the vision-language model, a first inference indicating whether the first user action corresponds to the first instruction, the means for generating, by the vision-language model, a first updated plan for performing the target activity based on the first inference, and/or the means for prompting, by the vision-language model, the user to perform a second user action based on the first updated plan. may for example, be the CPU (e.g., 102, 322), the GPU (e.g., 104, 326), and/or other processing unit (e.g., DSP 324, NPU 328), and/or memory 118 configured to perform the functions recited. In another configuration, the aforementioned means may be any module or any apparatus configured to perform the functions recited by the aforementioned means.

The various operations of methods described above may be performed by any suitable means capable of performing the corresponding functions. The means may include various hardware and/or software component(s) and/or module(s), including, but not limited to, a circuit, an application specific integrated circuit (ASIC), or processor. Generally, where there are operations illustrated in the figures, those operations may have corresponding counterpart means-plus-function components with similar numbering.

As used, the term “determining” encompasses a wide variety of actions. For example, “determining” may include calculating, computing, processing, deriving, investigating, looking up (e.g., looking up in a table, a database, or another data structure), ascertaining and the like. Additionally, “determining” may include receiving (e.g., receiving information), accessing (e.g., accessing data in a memory) and the like. Furthermore, “determining” may include resolving, selecting, choosing, establishing, and the like.

As used, a phrase referring to “at least one of” a list of items refers to any combination of those items, including single members. As an example, “at least one of: a, b, or c” is intended to cover: a, b, c, a-b, a-c, b-c, and a-b-c.

The various illustrative logical blocks, modules and circuits described in connection with the present disclosure may be implemented or performed with a general-purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, erasable programmable read-only memory (EPROM), electrically erasable programmable read-only memory (EEPROM), registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a device. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement signal processing functions. For certain aspects, a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and general processing, including the execution of software stored on the machine-readable media. The processor may be implemented with one or more general-purpose and/or special-purpose processors. Examples include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, random access memory (RAM), flash memory, read only memory (ROM), programmable read-only memory (PROM), erasable programmable read-only memory (EPROM), electrically erasable programmable Read-only memory (EEPROM), registers, magnetic disks, optical disks, hard drives, or any other suitable storage medium, or any combination thereof. The machine-readable media may be embodied in a computer-program product. The computer-program product may comprise packaging materials.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the device, all which may be accessed by the processor through the bus interface. Alternatively, or in addition, the machine-readable media, or any portion thereof, may be integrated into the processor, such as the case may be with cache and/or general register files. Although the various components discussed may be described as having a specific location, such as a local component, they may also be configured in various ways, such as certain components being configured as part of a distributed computing system.

The processing system may be configured as a general-purpose processing system with one or more microprocessors providing the processor functionality and external memory providing at least a portion of the machine-readable media, all linked together with other supporting circuitry through an external bus architecture. Alternatively, the processing system may comprise one or more neuromorphic processors for implementing the neuron models and models of neural systems described. As another alternative, the processing system may be implemented with an application specific integrated circuit (ASIC) with the processor, the bus interface, the user interface, supporting circuitry, and at least a portion of the machine-readable media integrated into a single chip, or with one or more field programmable gate arrays (FPGAs), programmable logic devices (PLDs), controllers, state machines, gated logic, discrete hardware components, or any other suitable circuitry, or any combination of circuits that can perform the various functionality described throughout this disclosure. Those skilled in the art will recognize how best to implement the described functionality for the processing system depending on the particular application and the overall design constraints imposed on the overall system.

The machine-readable media may comprise a number of software modules. The software modules include instructions that, when executed by the processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module. Furthermore, it should be appreciated that aspects of the present disclosure result in improvements to the functioning of the processor, computer, machine, or other system implementing such aspects.

If implemented in software, the functions may be stored or transmitted over as one or more instructions or code on a computer-readable medium. Computer-readable media include both computer storage media and communication media including any medium that facilitates transfer of a computer program from one place to another. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Additionally, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used, include compact disc (CD), laser disc, optical disc, digital versatile disc (DVD), floppy disk, and Blu-ray® disc where disks usually reproduce data magnetically, while discs reproduce data optically with lasers. Thus, in some aspects, computer-readable media may comprise non-transitory computer-readable media (e.g., tangible media). In addition, for other aspects computer-readable media may comprise transitory computer- readable media (e.g., a signal). Combinations of the above should also be included within the scope of computer-readable media.

Thus, certain aspects may comprise a computer program product for performing the operations presented. For example, such a computer program product may comprise a computer-readable medium having instructions stored (and/or encoded) thereon, the instructions being executable by one or more processors to perform the operations described. For certain aspects, the computer program product may include packaging material.

Further, it should be appreciated that modules and/or other appropriate means for performing the methods and techniques described can be downloaded and/or otherwise obtained by a user terminal and/or base station as applicable. For example, such a device can be coupled to a server to facilitate the transfer of means for performing the methods described. Alternatively, various methods described can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described to a device can be utilized.

It is to be understood that the claims are not limited to the precise configuration and components illustrated above. Various modifications, changes, and variations may be made in the arrangement, operation, and details of the methods and apparatus described above without departing from the scope of the claims.

What is claimed is:

1. An apparatus, comprising:
at least one memory; and
at least one processor coupled to the at least one memory, the at least one processor being configured to:
receive, by a vision-language model, a plan for performing a target activity;
process, by the vision-language model, the plan to generate one or more instructions for performing the target activity;
prompt, by the vision-language model, a user to perform a first user action based on a first instruction of the one or more instructions;
receive, by the vision-language model, at least a first frame of a video stream;
determine, by the vision-language model, a first inference indicating whether the first user action corresponds to the first instruction;
generate, by the vision-language model, a first updated plan for performing the target activity based on the first inference; and
prompt, by the vision-language model, the user to perform a second user action based on the first updated plan.

2. The apparatus of claim 1, wherein the at least one processor is further configured to output a first response to the user based on the first inference.

3. The apparatus of claim 2, wherein the vision-language model is trained to generate the first response at a timing based on the first user action.

4. The apparatus of claim 2, wherein the first response triggers generation of the first updated plan.

5. The apparatus of claim 1, wherein the first inference indicates that the first user action does not correspond to the first instruction and the at least one processor is further configured to determine, by the vision-language model, at least one corrective action to include in a next updated plan.

6. The apparatus of claim 1, wherein the plan includes a sequence of multiple instructions, and the at least one processor is further configured to:
receive, by the vision-language model, at least a second frame of the video stream;
determine, by the vision-language model, a second inference indicating whether the second user action corresponds to a next instruction of the first updated plan;
generate, by the vision-language model, a second updated plan for performing the target activity based on the second inference; and
prompt, by the vision-language model, the user to perform a third user action based on the second updated plan.

7. The apparatus of claim 1, wherein the vision-language model includes a recurrent state space model.

8. A processor-implemented method performed by one or more processors, the processor-implemented method comprising:
receiving, by a vision-language model, a plan for performing a target activity;
processing, by the vision-language model, the plan to generate one or more instructions for performing the target activity;
prompting, by the vision-language model, a user to perform a first user action based on a first instruction of the one or more instructions;
receiving, by the vision-language model, at least a first frame of a video stream;
determining, by the vision-language model, a first inference indicating whether the first user action corresponds to the first instruction;
generating, by the vision-language model, a first updated plan for performing the target activity based on the first inference; and
prompting, by the vision-language model, the user to perform a second user action based on the first updated plan.

9. The processor-implemented method of claim 8, further comprising outputting a first response to the user based on the first inference.

10. The processor-implemented method of claim 9, wherein the vision-language model is trained to generate the first response at a timing based on the first user action.

11. The processor-implemented method of claim 9, wherein the first response triggers generation of the first updated plan.

12. The processor-implemented method of claim 8, wherein the first inference indicates that the first user action does not correspond to the first instruction and the vision-language model determines at least one corrective action to include in a next updated plan.

13. The processor-implemented method of claim 8, wherein the plan includes a sequence of multiple instructions, and the processor-implemented method further includes:
receiving, by the vision-language model, at least a second frame of the video stream;
determining, by the vision-language model, a second inference indicating whether the second user action corresponds to a next instruction of the first updated plan;
generating, by the vision-language model, a second updated plan for performing the target activity based on the second inference; and
prompting, by the vision-language model, the user to perform a third user action based on the second updated plan.

14. The processor-implemented method of claim 8, wherein the vision-language model includes a recurrent state space model.

15. An apparatus, comprising:
means for receiving, by a vision-language model, a plan for performing a target activity;
means for processing, by the vision-language model, the plan to generate one or more instructions for performing the target activity;
means for prompting, by the vision-language model, a user to perform a first user action based on a first instruction of the one or more instructions;
means for receiving, by the vision-language model, at least a first frame of a video stream;
means for determining, by the vision-language model, a first inference indicating whether the first user action corresponds to the first instruction;
means for generating, by the vision-language model, a first updated plan for performing the target activity based on the first inference; and
means for prompting, by the vision-language model, the user to perform a second user action based on the first updated plan.

16. The apparatus of claim 15, further comprising means for outputting a first response to the user based on the first inference.

17. The apparatus of claim 16, wherein the vision-language model is trained to generate the first response at a timing based on the first user action.

18. The apparatus of claim 16, wherein the first response triggers generation of the first updated plan.

19. The apparatus of claim 15, wherein the first inference indicates that the first user action does not correspond to the first instruction and the apparatus further comprises means for determining, by the vision-language model, at least one corrective action to include in a next updated plan.

20. The apparatus of claim 15, wherein the plan includes a sequence of multiple instructions, and the apparatus further includes:
means for receiving, by the vision-language model, at least a second frame of the video stream;
means for determining, by the vision-language model, a second inference indicating whether the second user action corresponds to a next instruction of the first updated plan;
means for generating, by the vision-language model, a second updated plan for performing the target activity based on the second inference; and
means for prompting, by the vision-language model, the user to perform a third user action based on the second updated plan.
